(19) United States
(12) Patent Application Publication
(10) Pub. No.: US 2007/0159050 A1
(43) Pub. Date: Jul. 12, 2007

(54) Front face for cathode ray tube with reduced depth

(75) Inventors: Renzo Incagli, Colleferro (Roma) (IT); Francesco Di Giamberardino, Colleferro (Roma) (IT); Carlo Tulli, Roma (IT); Stefano Necci, Anagni (IT)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: Thomson Licensing

(21) Appl. No.: 11/594,257

(22) Filed: Nov. 8, 2006

(30) Foreign Application Priority Data
Nov. 9, 2005 (IT) 05A002139

(51) Int. Cl. H01J 29/86

(52) U.S. Cl. 313/477 R; 313/461

(57) ABSTRACT

Self-converging cathode ray tube with a deflection angle that is greater than 110°. The tube comprises a front panel supporting a luminescent screen surrounded by a flange perpendicular to the panel, the internal surface of the said panel being defined by radii of curvature Rdi along the diagonal, Rxi along the major axis and Ryi along the minor axis such that:
4≧Rdi/d≧2
0.8≧Ryi/Rdi≧0.4
1≧Rxi/Rdi≧0.7 Hence, the geometric distortion of the picture engendered by the self-converging deflection device is minimized, while enabling the shadow mask equipping such a tube to be less sensitive to thermal interferences.

The present invention relates to a cathode ray tube and more particularly to the front face of a tube whose thickness is determined so as to optimise the thermal behaviour of the shadow mask incorporated into the tube and to reduce the geometry distortion engendered by the magnetic deflection device of the beams mainly in the case where the beam angle deflection is greater than 110°. The invention also enables the transmission gradient of light emitted by the luminescent material screen of the tube through this optimised front face to be reduced as well as the weight of glass required to guarantee the mechanical strength when a vacuum is applied to the said tube.

### BACKGROUND OF THE INVENTION

Conventional cathode ray tubes comprise a colour selection mask situated inside the glass front face of the tube, front face on which networks of red, green and blue luminophores are laid to form a screen, the said front face being perpendicular to the longitudinal axis Z of the tube.

The mask is constituted by a metal sheet pierced in the middle part with many holes or slots. An electron gun arranged inside the rear part of the tube generates three electronic beams in the direction of the front face. An electromagnetic deflection device, known as a deviator, located outside the tube and close to the electron gun has the function of deviating the electron beams so as to sweep them over the surface of the panel on which the luminophore networks are arranged. Under the influence of the three electron beams each corresponding to a determined primary colour, the luminophore networks reproduce colour pictures on the screen, the mask enabling each determined beam to illuminate only the luminophore of the corresponding colour.

The colour selection mask must be arranged and maintained in a specific position within the tube during the operation of the tube. The mask support functions are realised owing to a generally very rigid rectangular metal frame on which the mask is conventionally welded. The frame/mask assembly is mounted in the front face using suspension means most frequently welded on the frame and co-operating with lugs inserted into the glass constituting the front face of the tube.

The front face of a cathode ray tube is generally constituted by an external surface defined by very large radii, and by an internal surface of smaller radii such that the thickness of this face is smaller at its centre than at the edges, this is in order to guarantee the mechanical strength against implosion when a vacuum is applied within the tube.

However, as the profile of the shadow mask noticeably follows the profile of this internal surface, the said mask profile also tends to be defined by large radii of curvature. The result is that the mask can become very sensitive to local heating if its curvature is too small.

This sensitivity can cause interference movements of the mask and engender discolorations of the picture created on the screen of the tube. It is thus common to use a mask made of a material not sensitive to heat increases, for example in invar. However, this material is more expensive than conventional “killed” steel and mechanically more difficult to shape.

Moreover, if the internal surface tends to be defined by large radii of curvature, the picture formed on the screen of the tube by the deflection of the electron beams sent from the canon will undergo geometry deformations that will be difficult to correct and will require additional resources such as for example magnetic shunts or correction magnets to achieve this.

In the case where, to improve the contrast of the picture formed on the screen of the tube, the front face uses a dark glass of lower transparency for example 80%, the differences in glass thickness between the centre and the edges of the screen are such that the luminosity of a picture will not be rendered uniformly between the said centre and the said edges.

The current trend of reducing the depth of the cathode ray tubes requires the use of deflection systems that permit greater deflection angles than in the past and therefore greater than 110°. These large angles make the problems identified above even more present.

### SUMMARY OF THE INVENTION

One of the purposes of the invention is to describe a method of manufacturing a glass bulb for a reduced length cathode ray tube that tends to optimise the design of the said bulb to minimise the problems described above.

For this, a cathode ray tube according to the invention is constituted by a glass envelope comprising:
a panel of a noticeably rectangular form defined by two axes of symmetry, the major horizontal axis X and the minor vertical axis Y cross at its centre O, the said panel being constituted by a front face supporting a luminophore screen on its internal surface with a diagonal equal to d, surrounded by a peripheral flange extending in a direction noticeably perpendicular to the screen, the internal surface of the front face has a radius of curvature Rdi, measured along the diagonal of the screen, Rxi along the major axis, Ryi along the minor axis
a rear part in the form of a funnel, the tapered free edge of which is sealed at the extremity of the flange of the panel
an electron gun to generate the electron beams intended to sweep over the luminescent screen according to a maximum deflection angle Θm

the envelope being characterized in that:
Θₘ>110
4≧Rdi/d≧2
1≧Rxi/Rdi≧0.7
0.8≧Ryi/Rdi≧0.4

### BRIEF DESCRIPTION OF THE DRAWINGS

The invention and its different advantages will be better understood from the following description and drawings, wherein:

FIG. 1 is a cross-section view of a cathode ray tube according to the invention, the cross-section being made in a plane containing the longitudinal axis Z of the tube and a diagonal of the screen

FIG. 2 is a front view of the front panel of the tube

FIG. 3 specifies the different characteristics implemented to produce the invention.

FIG. 4 shows a transversal cross-section of the internal surface of the screen

FIG. 5 illustrates the geometrical distortions of the screen picture caused by a self-converging deflection device

FIGS. 6 to 10 show the changes in the distortion of the picture obtained by varying the different radii of curvature of the internal surface supporting the screen.

FIG. 11 shows the domain according to the invention in which the defining parameters of the bulb constituting the tube are chosen.

### DESCRIPTION OF THE PREFERRED EMBODIMENT

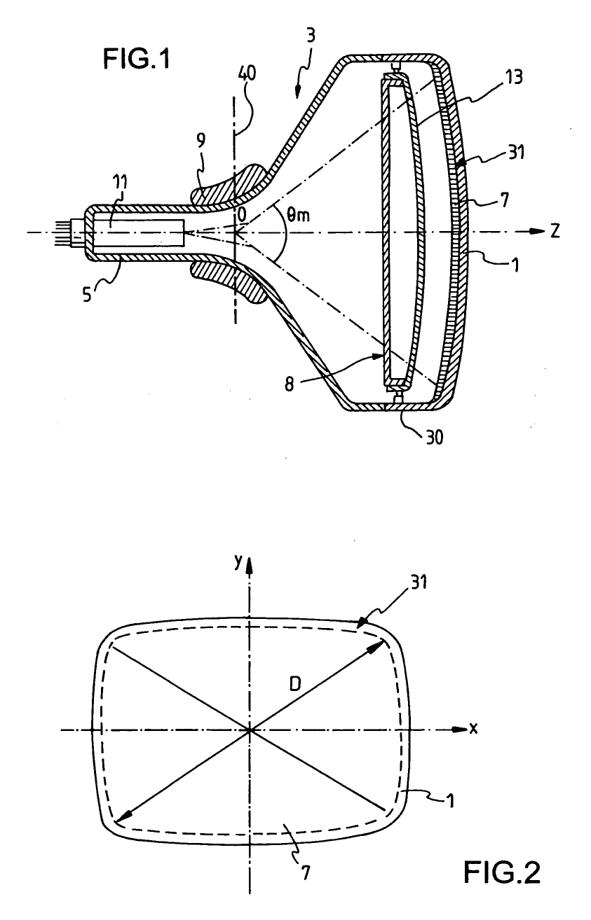

As shown in FIG. 1, a cathode ray tube comprises a central, longitudinal axis Z passing through the centre of the cylindrical collar 5 and through the middle of the panel 1. The panel supports a luminophore screen 7 realising a coloured picture when it is swept by the electron beams from the canon 11. The electron beams are deviated by a magnetic deflection device 9 arranged at the back of the tapered part 3 in the form of a funnel, sealed at one end to the cylindrical collar and at the other end to the peripheral flange 30 of the panel 1, the said flange extending in a direction noticeably parallel to the longitudinal axis Z. A colour selection mask (13), supported by a rigid frame (8), is arranged on the trajectories of the electron beams to ensure that each beam only illuminates the luminescent materials that correspond to it.

To sweep over the entire surface of the screen 7, the electron beams must be deviated to sweep the entire useful surface of the luminescent screen 7. Once the electrons have left the zone of influence of the magnetic deviation device, their trajectories become noticeably rectilinear and appear to emanate, by prolongation of the rectilinear part of their trajectories, from the point O called deflection centre. The angle formed by the straight lines connecting the point O to the two opposite extremities of a diagonal of the screen 7 is the deflection angle Θm.

FIG. 2 shows a front view of the front face 31 of the panel 1, a noticeably rectangular face, with the large sides arranged according to directions parallel to the horizontal axis X, and the small sides arranged according to directions parallel to the vertical axis Y.

The plane containing the point O, perpendicular to the longitudinal axis Z, determines, in the cut plane of FIG. 1, what those skilled in the art generally call the reference line 40 of the tube. This line is the reference serving to position the different components of the tube (deviator 9, canon 11, etc.) in relation to each other.

As illustrated by FIG. 5, the picture of a rectangle ABCD will only be displayed as such if the surface of the screen is a perfect sphere and the deflection system of the electron beams has no geometry error to correct. As this does not reflect the reality, the radii of curvature being different (for example according to the horizontal, vertical or diagonal directions) a geometry distortion of the picture appears in the form of a cushion or barrel, following the north/south direction (a,b) and following the east/west direction (c,d). The distortion percentage is measured in the following manner:

$$North \text{/} south distortion \text{:} = \frac{2 ( a + b )}{AD + BC} \cdot 100$$

$$East \text{/} west distortion \text{:} = \frac{2 ( c + d )}{AB + CD} \cdot 100$$

It is known that the self-converging fields engendered by the deflection system can be modelled so as to correct, without any additional device, distortion percentages that do not exceed 3%.

To produce a cathode ray tube, large thicknesses of glass are generally used to maintain the mechanical strength of the tube against implosion: the tubes according to prior art show a very large thickness of glass on the peripheral edges of the screen, a thickness that decreases toward the centre of the said screen. Moreover, the use of the tubes in surroundings that can be highly luminous requires a screen showing a high contrast to be obtained. This contrast is generally obtained using a front panel of dark glass, that is having a light transmission coefficient lower than 80%. However, the use of a dark glass panel of variable thickness between the centre and the edge causes a high light transmission gradient through the said panel and this non-uniformity of transmission thus becomes visible and inconvenient for the viewer.

The current trend of decreasing the depth of the tubes by increasing the angle of deflection (which thus becomes greater than 110°) makes these phenomena still more visible as it occurs through an increase in the glass thickness to resist the mechanical stress acting on the panel.

The definition parameters of the glass envelope of the tube used within the framework of the invention are:
the diagonal of the phosphor screen equal to d
the format f of the screen (length/width ratio); this ratio is conventionally equal either to 4/3 or to 16/9; if the rectangular screen has a width equal to 2Xmax and a height equal to 2Ymax, one can write Ymax=

$$\frac{d}{2 \sqrt{1 + {f}^{2}}}$$

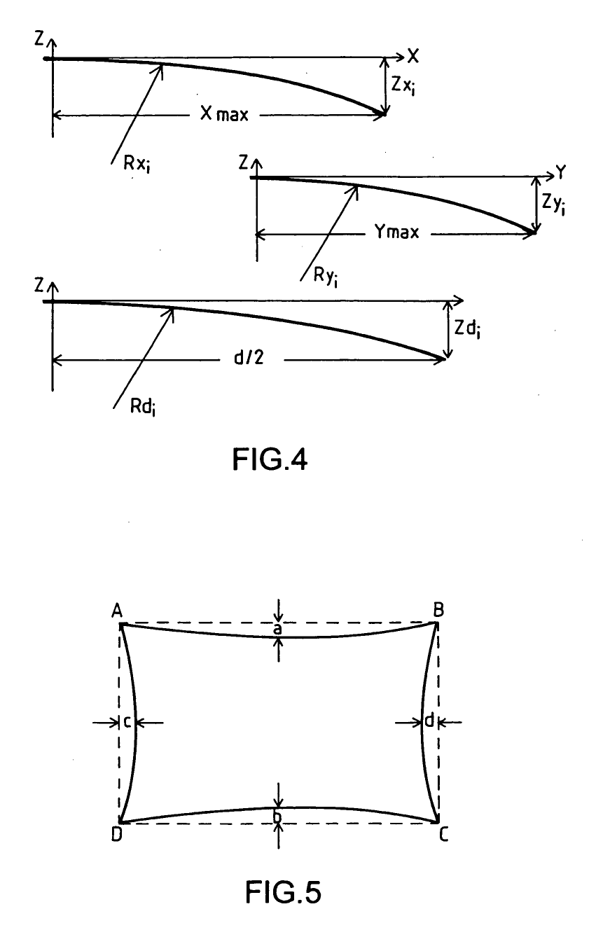

and Xmax=f.Ymax
as shown in FIG. 4, the curvature of the internal and external surfaces of the panel supporting the screen is generally defined by the difference in position according to the direction of the longitudinal axis Z, of different points of the periphery of the screen with respect to the position according to Z of the centre of the said screen; the differences are generally considered along the diagonal, Zd, along the major axis, Zx, and along the minor axis Zy.
the average radii of the internal surface according to the three directions (major, minor and diagonal axes) can be written:

$$Rxi = \frac{{Zxi}^{2} + {Xmax}^{2}}{2 Zxi}$$

$$Ryi = \frac{{Zyi}^{2} + {Ymax}^{2}}{2 Zyi}$$

$$Rdi = \frac{{Zdi}^{2} + {Xmax}^{2} + {Ymax}^{2}}{2 Zdi}$$

The glass envelope of the tube is modelled within the framework of the invention with a view to optimising the behaviour of the mask, in particular when this mask is made of killed steel, in such a manner as to make it less sensitive to heating and to mechanical vibrations by the optimisation of the internal surface of the section of the front face supporting the luminescent screen, an optimisation that also integrates the minimisation of the geometrical distortion of the picture created by the magnetic deflection device so that this distortion is at most in the order of 3%.

The modelling of the internal surface of the section of the front face on which the luminescent screen is found, using the analysis by finished elements enabled, within the framework of the invention, these constraints to be integrated and determines the parameters and ranges of values of these parameters enabling the required optimisation to be reached.

Studies conducted within the framework of the invention have thus shown that the sensitivity of a mask to thermal variation can be brought to an acceptable level for a tube whose maximum deflection angle is greater than 110°, particularly when this mask has a relatively high thermal dilation coefficient like that of killed steel, when the average radii of curvature Rdi, Rxi, Ryi defining the part of the internal surface of the front face on which the luminescent screen is found, radii of curvature from which those of the mask are defined, are chosen so as to verify the following relationships simultaneously:

$$\begin{matrix}4 \geq Rdi / d \geq 2 \\ 0.8 \geq Ryi / Rdi \geq 0.4 \\ 1 \geq Rxi / Rdi \geq 0.7\end{matrix} \} \qquad ( 1 )$$

If Rdi is greater than 4, the internal profile becomes very flat, like the profile of the mask positioned opposite; the mask then no longer has sufficient mechanical strength for the local thermal disturbances or the mechanical vibrations of the environment. Conversely, if Rdi is below 2, the internal profile of the front face becomes highly curved, the mask becomes mechanically more rigid but the glass thicknesses of the face are very different between the centre and the edge; causing a significant non-uniformity in the light yield of the picture between the centre and the periphery.

Within the framework of the invention, for a tube with a screen diagonal of 676 mm, format 4/3, and a maximum deflection angle equal to 120°, the profile of the internal surface on which the luminescent screen is situated was defined by:

Rdi=2015 mm; Rxi=1697 mm; Ryi=1107 mm

Rdi/d=2.98; Rxi/Rdi=0.84; Ryi/Rdi=0.54

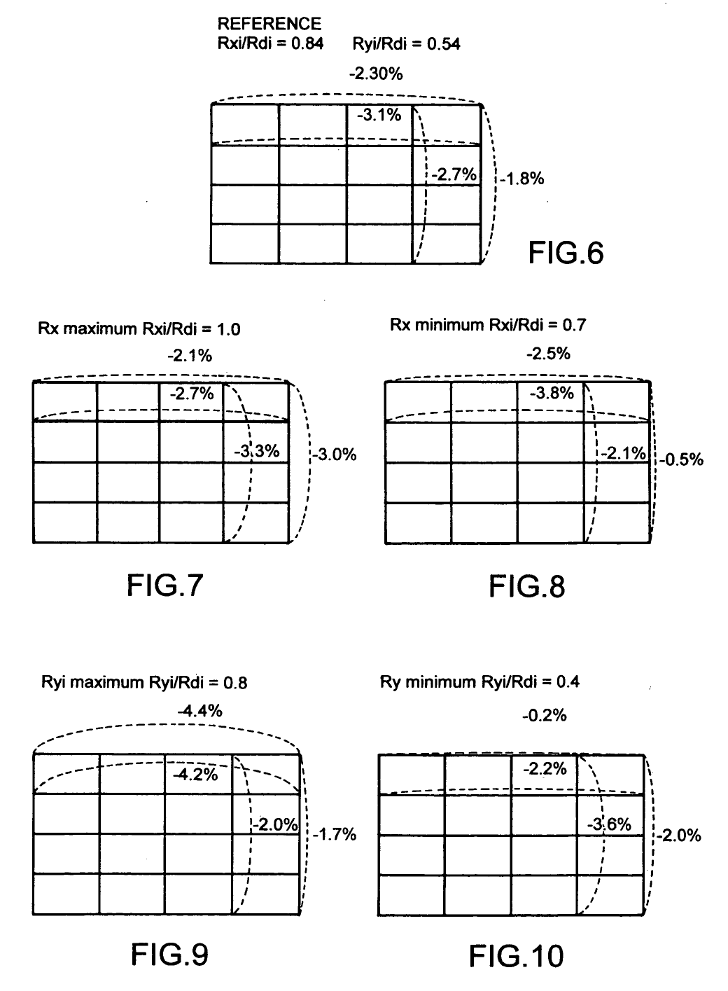

FIG. 6 illustrates the north/south and east/west distortions of the picture on the screen created by the self-converging deflection device. The perfect picture is in solid lines and the real picture is in dotted lines. The values of Rdi, Rxi and Ryi give geometric distortions of the picture within an acceptable range.

FIGS. 7 to 10 show the changes in the distortion of the picture created on the screen according to the Rxi/Rdi and Ryi/Rdi ratios with respect to the reference of FIG. 6 when these ratios are varied while keeping the value of Rdi at 2015 mm. Hence, when the value of Rxi/Rdi increases to 1, the east/west distortion becomes very large, as when Ryi/Rdi tends to become less than 0.4; when Rxi/Rdi tends to become less than 0.7, it is the north/south distortion that tends to become to strong, just as when Ryi/Rdi tends to become greater than 0.8.

It is desirable that the light transmission gradient of the front face should be as uniform as possible between the centre and the edges of the said front face; the differences in glass thickness are the source of these transmission variations that are all the more visible as the glass constituting the front face becomes darker.

Within the framework of the invention, it was determined that the radii of curvature of the external and internal surfaces of the part of the front face supporting the screen must be chosen in such a manner as to respect the following relationships:

$$\begin{matrix}0 \leq Zdi - Zde \leq 6.1 mm \\ 0 \leq Zxi - Zxe \leq 6.1 mm \\ 0 \leq Zyi - Zye \leq 6.1 mm\end{matrix} \} \qquad ( 2 )$$

where Zdi, Zxi, Zyi represent the differences in position according to the direction of the longitudinal axis Z between the centre of the screen and the extremities of the screen according respectively to the diagonal, the major axis, the minor axis and Zde, Zxe, Zye represent for the external surface of the part of the front face in which the screen is found, the difference in position according to the direction of the longitudinal axis Z between the centre of this part and its extremities along the respective directions of the diagonal, the major axis and the minor axis.

These relations are particularly advantageous when the glass of the front panel is dark and in particular when the light transmission coefficient of the said panel is chosen so as to be less than 80%.

The optimisation of the quantity of glass to use is crucial from an economic point of view (reduced material cost and reduced manufacturing costs) for a tube with a maximum deflection angle that is greater than 110° as the local mechanical stresses acting on its surface following the application of a vacuum are, owing to its geometry, greater than for a tube using a lower deflection angle.

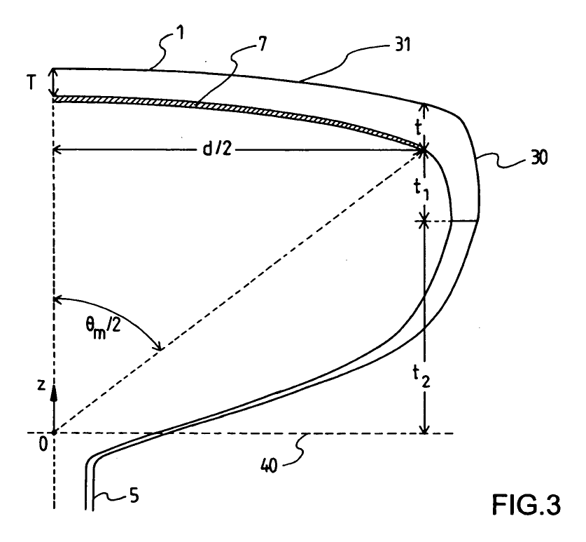

Within the framework of the invention, it is possible to optimise the quantity of glass to use, aiming to minimise the quantity of glass to produce the bulb while retaining a sufficient mechanical strength against implosion; the study showed that the parameter A, A being equal to (t1+t/t2 (where, in accordance with FIG. 3, t is the thickness of the front face at the extremity of the diagonal of the screen, t1 is the distance between the corner of the screen and the free edge of the flange of the front part of the tube and t2 is the distance between the tapered free edge of the rear part 3 in the form of a funnel and the reference line of the tube), must be kept within a certain value range without which the tube becomes too heavy or too fragile.

Experience has shown that this parameter A depends on the maximum deflection angle Θm in such a manner that its ideal value is expressed by the relationship:
A(Θm)=[0.0055.Θm−0.011]. (3)

for which Θm is expressed in degrees.

However, experience also shows that a certain tolerance is acceptable for establishing compromises with the other parameters to respect for producing the bulb. Hence, respecting the relation:

$$\frac{t 1 + t}{t 2} = A ( Θ m ) \pm 0.1$$

enables the optimisation sought to be obtained with more latitude on the geometric parameters defining the bulb.

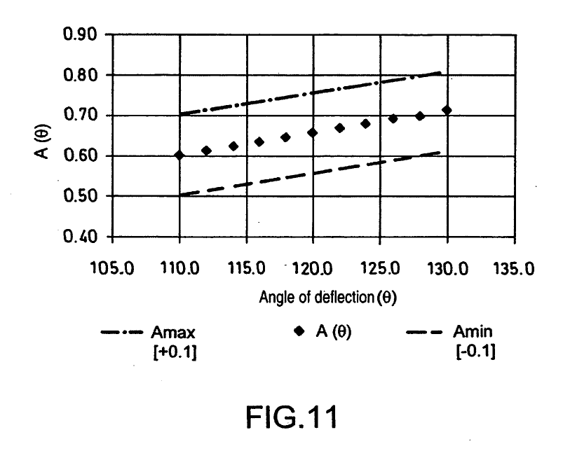

FIG. 11 illustrates the domain in which the ratio (t1+t)/t2 can be chosen advantageously according to the deflection angle Θm.

Hence, for a tube of 4/3 format, with a diagonal equal to 676 mm and a deflection angle equal to 120°, the different parameters defining the characteristics of the bulb, established according to the method conforming to the invention are summarized in the following table:

| Constraints according | |
|---|---|
| to the invention | Chosen values of the parameters |
| 4 ≧ Rdi/d ≧ 2 | Rdi = 2015/676 = 2.98 |
| 0.8 ≧ Ryi/Rdi ≧ 0.4 | Ryi/Rdi = 1107/2015 = 0.54 |
| 1 ≧ Rxi/Rdi ≧ 0.7 | Rxi/Rdi = 1697/2015 = 0.84 |
| Zdi − Zde ≦ 6.1 mm | Zdi − Zde = 28.55 − 23.96 = 4.59 mm |
| Zxi − Zxe ≦ 6.1 mm | Zxi − Zxe = 21.68 − 19.32 = 2.36 mm |
| Zyi − Zye ≦ 6.1 mm | Zyi − Zye = 18.74 − 15.51 = 3.23 mm |
| $\frac{t 1 + t}{t 2} = A ( Θm ) \pm 0.1$ | $\begin{matrix}A ( Θm ) = 0.66 \pm 0.1 \\ A ( Θm ) = \frac{69.95 + 17.59}{127} = 0.698\end{matrix}$ |

The bulb can therefore be characterized according to the following process:
determination of the internal surface according to the relationships (1)
the external surface is defined by starting from a thickness at the centre T enabling sufficient mechanical strength against implosion to be obtained, according to the methods known by those skilled in the art for designing a cathode ray tube envelope and possibly optimised according to the relationships (2) to obtain an improved homogeneity of the light transmission.
so as to present the required characteristics of mechanical performance in a vacuum and possibly optimised according to the relationships (2), the values t1 and t2 are chosen so as to conform to the relationships (3) given that the sum (t1+t2) is determined by the size of the diagonal of the screen and the angle Θm, and that t is the thickness of the front face at the extremity of the diagonal.

The relationships (1), (2) and (3) can be implemented independently from each other according to the results required.

Although the invention was realized for panel tubes having a noticeably curved profile, it can be advantageously applied to design tubes with a front face that is noticeably flat.

1. Cathode ray tube constituted by a glass envelope comprising:
a panel of a noticeably rectangular form defined by two axes of symmetry, the major horizontal axis X and the minor vertical axis Y crossing at its centre O, the said panel being constituted by a front face supporting, on its internal surface, a luminophore screen of diagonal equal to d, surrounded by a peripheral flange extending in a direction noticeably parallel to the longitudinal axis Z of the tube passing through the centre of the front face, the internal surface of the front face has a radius of curvature Rdi, measured along the diagonal of the screen, Rxi along the major axis, Ryi along the minor axis, the said panel moreover being defined by a thickness t at one corner of the screen and by a distance t1 between the corner of the screen and the free edge of the flange, measured according to the direction of the Z axis,
a colour selection mask of rectangular shape defined by two axes of symmetry, the major horizontal axis X and the minor vertical axis Y crossing at the centre O of an active surface drilled with holes,
a noticeably rectangular frame to which the mask is joined
a rear part in the form of a funnel, the tapered free edge of which is sealed at the extremity of the flange of the panel, this free edge being arranged at a distance t2 from the reference line of the tube, measured according to the direction of the Z axis,
an electron gun to generate the electron beams intended to sweep over the luminescent screen according to a maximum deflection angle Θₘ
wherein:
Θₘ>110°
and
4≧Rdi/d≧2
0.8≧Ryi/Rdi≧0.4
1≧Rxi/Rdi≧0.7

2. Cathode ray tube according to claim 1, wherein the internal and external surfaces of the front face are:
0≦Zdi−Zde≦6.1 mm
0≦Zxi−Zxe≦6.1 mm
0≦Zyi−Zye≦6.1 mm
where Zdi, Zxi, Zyi represent the differences in position according to the direction of the longitudinal axis Z between the centre of the screen and the extremities of the screen according respectively to the diagonal, the major axis, the minor axis and Zde, Zxe, Zye represent for the external surface of the part of the front face in which the screen is found, the difference in position according to the direction of the longitudinal axis Z between the centre of this part and its extremities along the respective directions of the diagonal, the major axis and the minor axis.

3. Cathode ray tube according to claim 1, wherein the ratio A=(t1+t)/t2 is chosen within a range of values such that:
$$\frac{t 1 + t}{t 2} = A ( Θ m ) \pm 0.1$$
for which Θm is expressed in degrees.

4. Cathode ray tube according to claim 1, wherein the light transmission coefficient of the panel is less than 80%.

5. Cathode ray tube according to claim 1, wherein the mask is made of killed steel.
